(19) United States
(12) Patent Application Publication
(10) Pub. No.: US 2014/0151520 A1
(43) Pub. Date: Jun. 5, 2014

(54) Stabilizing Device

(71) Applicant: William Warren Cato, JR., Atlanta, GA (US)

(72) Inventor: William Warren Cato, JR., Atlanta, GA (US)

(21) Appl. No.: 13/693,395

(22) Filed: Dec. 4, 2012

(51) Int. Cl. F16M 13/02

(52) U.S. Cl. CPC F16M 13/02
USPC 248/316.1; 248/200; 29/428

(57) ABSTRACT

Disclosed are various embodiments for a stabilizing device for stationary equipment, such as an automatic teller machine, to secure the equipment to an anchor. In one embodiment, the stabilizing device is configured to overcome a dislodging force that may be applied to the stationary equipment such that the equipment does not roll over and spill its payload. In one embodiment, the stabilizing device has a back plate and a front plate with dimensions that facilitate effectively stabilizing the stationary equipment. Additionally, the front plate includes a side wall and a base wall that correspond to the dimensions of the stationary equipment.

### BACKGROUND

Stationary equipment capable of dispensing various items can be found in a variety of locations. For example, vending machines that dispense food and beverages can be found in schools, offices, hotels, and other locations. Additionally, automatic teller machines (ATMs) that dispense cash can be found in stores, malls, restaurants, and other locations. In many instances, these types of stationary equipment are not monitored and are unattended.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIGS. 1-2 and 4 are drawings of a stabilizing device according to various embodiments of the present disclosure.

FIG. 3 is a drawing of a back plate of the stabilizing device according to various embodiments of the present disclosure.

FIG. 5 is a drawing of the stabilizing device of FIGS. 1-4 affixed to a stationary machine according to various embodiments of the present disclosure.

FIG. 6 is a flowchart illustrating one example of functionality implemented as portions of the device of FIGS. 1-4 according to various embodiments of the present disclosure.

### DETAILED DESCRIPTION

The present disclosure relates to stabilizing stationary equipment to an anchor with a device to withstand and resist a dislodging force that may be applied. In the following discussion, a general description of the system and its components is provided, followed by a discussion of the operation of the same.

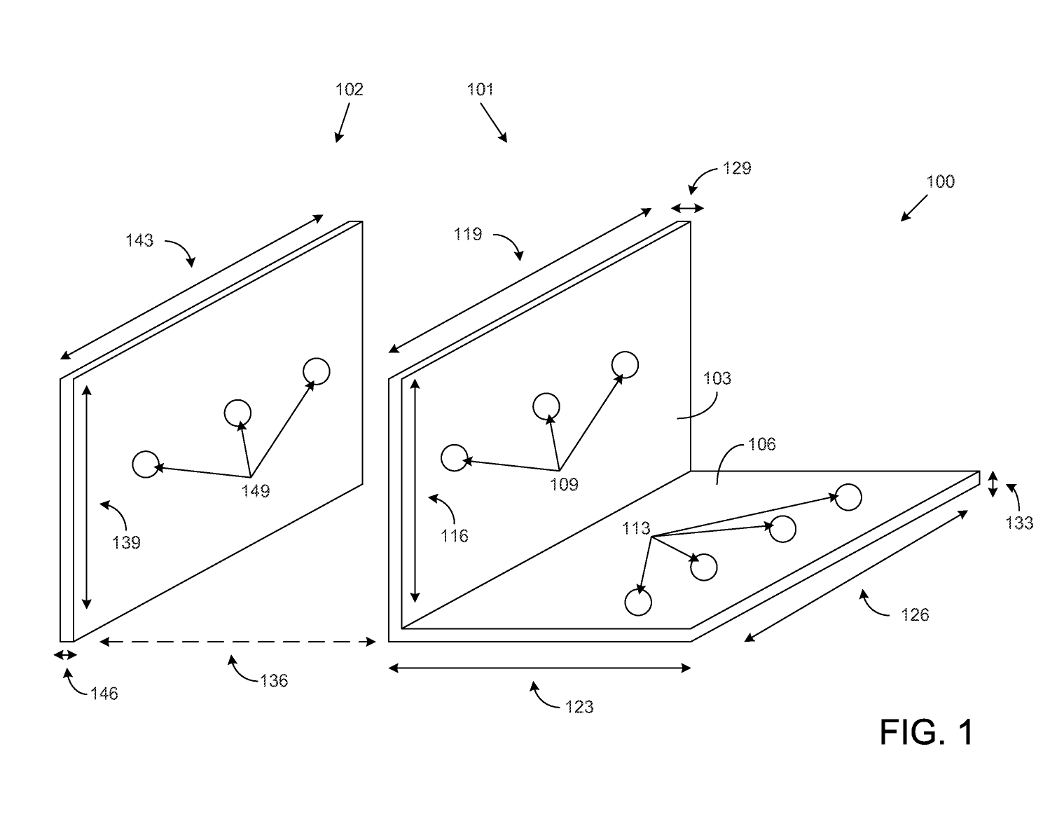

With reference to FIG. 1, shown is a device 100, according to various embodiments, that may be used to stabilize stationary equipment such that the device enables the stationary equipment to withstanding and resist a dislodging force that may be applied. As such, the device 100 may prevent the stationary equipment from rolling over and spilling its payload for a predefined period of time. The device 100 includes a front plate 101 and a back plate 102. In one embodiment, the front plate 101 is displaced on the exterior of the stationary equipment and the back plate 102 is displaced on the interior of the stationary equipment. The front plate 101 includes a side wall 103 and a base wall 106 and may be manufactured from heavy gauge steel, heavy gauge aluminum, and/or any other type of material. In one embodiment, the side wall 103 includes a plurality of securing holes 109 configured to secure the side wall to the stationary equipment, as will be discussed. For instance, the securing holes 109 may be configured to receive a threaded screw, a nut and bolt device, and/or any other securing device to secure the side wall 103 to the stationary equipment.

Additionally, the base wall 106 includes a plurality of anchoring holes 113 configured to anchor the base wall to an anchor. For instance, the anchoring holes 113 may be configured to receive a concrete screw, a concrete bolt, and/or any other anchoring device to anchor the base wall 106 to an anchor. Further, the anchor may be a concrete floor, a concrete foundation, and/or any other type of anchor capable of anchoring the stationary equipment. In one embodiment, the side wall 103 angularly intersects the base wall 106 to form a 90° angle. In another embodiment, the side wall 103 and the base wall 106 are two parallelepiped bodies that stabilize the stationary equipment when they angularly intersect.

In addition, the side wall 103 has a side height 116 and a side length 119. Similarly, the base wall 106 has a base width 123 and a base length 126. In one embodiment, the side height 116 and the base width 123 may vary in size. For instance, the side height 116 may be of an optimal size to effectively secure the stationary equipment, as will be described. Additionally, the base width 123 may also be of an optimal size to effectively anchor the stationary equipment. In another embodiment, the side length 119 and the base length 126 may be substantially similar in size. For example, the side length 119 and the base length 126 may correspond to a length, depth, weight, construction and/or other feature of the stationary equipment. In particular, the side length 119 and the base length 126 may correspond to the stationary equipment depth to effectively stabilize the equipment. In another embodiment, the side length 119 and the base length 126 may vary in size based at least in part on the features of the stationary equipment.

Additionally, the side wall 103 has a side thickness 129 and the base wall 106 has a base thickness 133. In one embodiment, the side thickness 129 and the base thickness 133 may be substantially similar in size and may correspond to a size and weight of the stationary equipment. For example, heavier and/or bulkier stationary equipment may correspond to a thicker side thickness 129 and base thickness 133 to effectively stabilize the equipment. In another embodiment, the side thickness 129 and the base thickness 133 may vary in size based at least in part on the features and/or dimensions of the stationary equipment.

Next, the back plate 102 is displaced on the interior of the stationary equipment to strengthen the device 100. For instance, a portion of the stationary equipment may be positioned in the space 136 such that the back plate 102 is on the interior of the stationary equipment and the front plate 101 is positioned on the exterior of the stationary equipment. In one embodiment, the dimensions of the back plate 102 may be substantially similar to the side wall 103 of the front plate 101 to effectively strengthen the device 100. For example, the back plate 102 has a back height 139 that may be substantially similar to the side height 116 of the front plate 101, a back length 143 that may be substantially similar to the side length 119, and a back thickness 146 that may be substantially similar to the side thickness 129. In another embodiment, the dimensions of the back plate 102 may differ from the dimensions of the side wall 103 and may be of an optimal size to effectively strengthen the device 100. For example, the magnitude of the back height 139, the back length 143, and the back thickness 146 may correspond to a length, depth, weight, construction, and/or other feature of the stationary equipment.

In addition, the back plate 102 includes a plurality of strengthening holes 149 configured to strengthen the device 100 as it stabilizes the stationary equipment. For instance, the strengthening holes 149 may be configured to receive a threaded screw, a nut and bolt device, and/or any other strengthening device to strengthen the device 100 as it stabilizes the stationary equipment. In one embodiment, the strengthening holes 149 may be substantially similar to the securing holes 109 in size and dimension. In this example, the strengthening devices received by the back plate 102 and the securing devices received by the side wall 103 may be the same. For instance, the strengthening devices and/or securing devices may be received by the securing holes 109 in the side wall 103, go through the stationary equipment adjacent to the side wall 103, and then be received by the strengthening holes 149 in the back plate 102. Thus, the same devices function as both the securing devices and the strengthening devices.

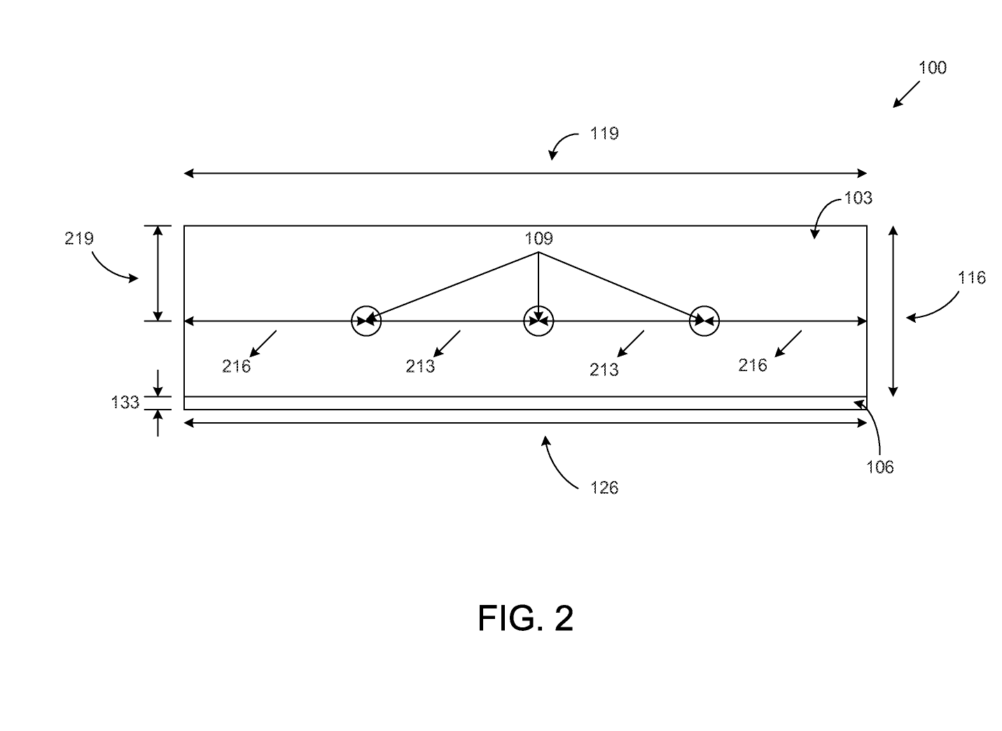

Referring next to FIG. 2, shown is a front view of the front plate 101. In this figure, a front view of the side wall 103 and the base wall 106 are visible. In one embodiment, the visibility of the base wall 106 may depend on the base thickness 133 where a larger base thickness 133 results in a more visible base wall 106. Additionally, in this example, the side wall 103 and the base wall 106 share a substantially similar side length, i.e. the side length 119 is substantially similar to the base length 126. In another embodiment, the side length 119 may be different in size relative to the base length 126 based at least in part on the features and/or dimensions of the stationary equipment.

Next, the side wall 103 includes a plurality of securing holes 109 dispersed along the wall. In one embodiment, the side wall 103 may include three securing holes 109 that are used to secure the side wall 103 to the stationary equipment. In particular, the securing holes 109 may be configured to receive a threaded screw, a bolt, a nail, and/or any other securing device capable of securing the device 100 to the stationary equipment. Additionally, the diameter of the securing holes 109 may vary based at least in part on the diameter of the securing devices that the securing holes 109 are configured to receive. In one embodiment, the diameter of the securing devices correspond to a size and weight of the stationary equipment. For instance, a larger securing device may be required to effectively secure larger and/or heavier stationary equipment. As an example, the securing devices may be ⅝″ in diameter and thus would require securing holes 109 that correspond to that diameter. Further, when securing devices are inserted into the securing holes 109 and firmly applied, the side wall 103 becomes affixed to the stationary equipment. In one embodiment, the securing devices are inserted into the securing holes 109, go through the stationary equipment, and are received by the strengthening holes 149 in the back place 102, as described above.

In one embodiment, the securing holes 109 may be dispersed evenly along a horizontal axis of the side wall 103. In particular, a side edge space 216 between an outer edge of the side wall 103 and a securing hole 109, and a securing hole space 213 between the securing holes 109 may vary in size based at least in part on the side length 119. For instance, the side edge space 216 and the securing hole space 213 may vary in size to ensure that the securing holes 109 are dispersed evenly. In one embodiment, evenly dispersed securing holes 109 may be necessary to effectively secure the stationary equipment. For example, assuming that the side length 119 is 22″, the side edge space 216 and the securing hole space 213 may each be 5½″ to ensure that the securing holes 109 are dispersed evenly along a horizontal axis of the side wall 103.

In another embodiment, the securing holes 109 may be dispersed unevenly along the horizontal axis of the side wall 103. For instance, the securing holes 109 may need to be dispersed based on the size, weight and construction of the stationary equipment. The side edge space 216 and the securing hole space 213 may differ in size in order to effectively secure the stationary equipment. For example, the construction of the stationary equipment, such as a protrusion in the equipment, may require unevenly dispersed securing holes 109.

In yet another embodiment, the horizontal axis on which the securing holes 109 are located may be found at any height along the side height 116. For instance, the height at which the horizontal axis may be found is based at least in part on the size, weight and construction of the stationary equipment. In this example, the horizontal axis is found at a side midpoint 219 of the side height 116. For instance, if the side wall 103 has a side height 116 of 4½″, then the securing holes 109 may appear at side midpoint 219 of 2¼″. In other embodiments, the horizontal axis may be closer to the base wall 106 and/or further away from the base wall 106 based at least in part on the size, weight and construction of the stationary equipment. In addition, in another embodiment, the securing holes 109 may not all be located on a horizontal axis. For instance, each of the securing holes 109 may be located at different heights along the side height 116.

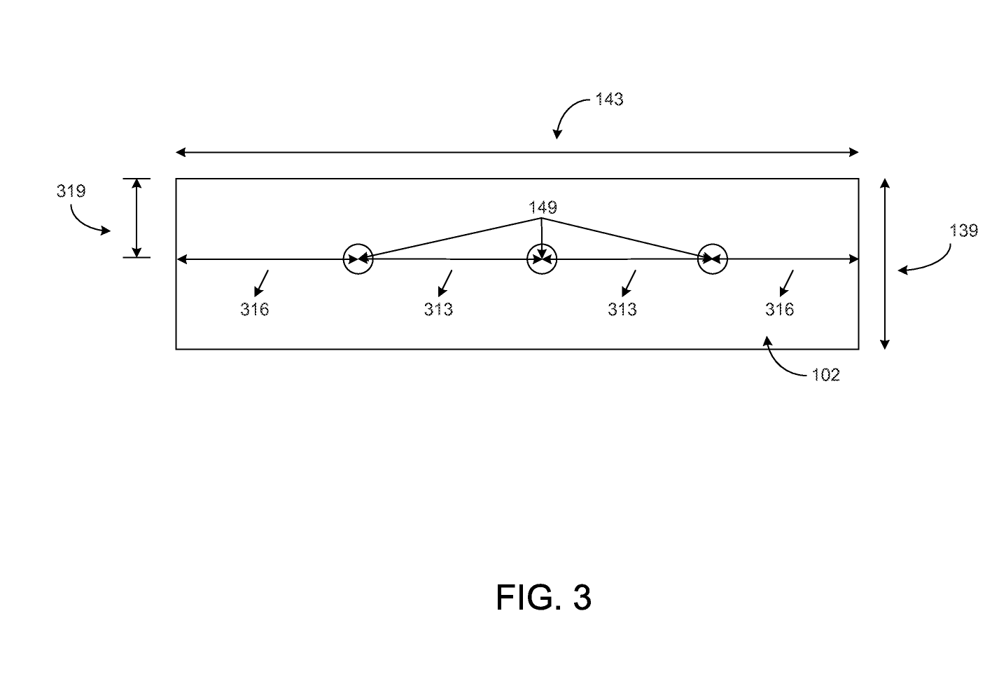

Turning now to FIG. 3, shown is one embodiment of the back plate 102. Here, the back plate 102 has a back height 139, a back length 143, and a base thickness 146. In one embodiment, the magnitude of the back height 139, the back length 143, and the back thickness 146 may correspond substantially to the magnitude of the side height 116, the side length 119 and the side thickness 129, respectively. In another embodiment, the magnitude of the back height 139, the back length 143 and the back thickness 146 corresponds to the features and/or dimensions of the stationary equipment. Furthermore, the back plate 102 may also include a variety of slots and/or grooves of varying dimensions to facilitate any bolts, screws, and/or other devices that may already be affixed on the interior of the stationary equipment. For instance, the slots and/or grooves are configured to help slide the back plate 102 over the affixed screws and/or bolts for a uniform displacement on the interior of the stationary equipment.

In one embodiment, each of the strengthening holes 149 on the back plate 102 may correspond to a respective one of the securing holes 109 on the side wall 103. For instance, the strengthening holes 149 may be displaced along the back plate 102 such that they are aligned with the securing holes 109 in order for a device, such as a securing device and/or a strengthening device, to be inserted into one of the securing holes 109, pushed through the stationary equipment, and then received by the corresponding one of the strengthening holes 149. In another embodiment, the strengthening holes 149 are not aligned with the securing holes 109. As such, in this embodiment, the strengthening holes 149 receive strengthening devices that are separate from the securing devices received by the securing holes 109.

In yet another embodiment, the back plate 102 may include three strengthening holes 149 as depicted in FIG. 3 that are used to strengthen the device 100 while it is stabilizing the stationary equipment. In particular, the number of strengthening holes 149 may correspond to the number of securing holes 109. The strengthening holes 149 may be configured to receive a threaded screw, a bolt, a nail, and/or any other strengthening device capable of strengthening the device 100 while it is securing the stationary equipment. Additionally, the diameter of the strengthening holes 149 may vary based at least in part on the diameter of the strengthening devices that the strengthening holes 149 are configured to receive. In one embodiment, the diameter of the strengthening devices corresponds to a size and weight of the stationary equipment. For instance, a larger strengthening device may be required to effectively strengthen the device 100 while it is stabilizing larger and/or heavier stationary equipment.

In addition, the strengthening holes 149 may be dispersed evenly or unevenly along a horizontal axis of the back plate 102. For example, the back edge space 316 and the strengthening hole space 313 may be substantially similar if the strengthening holes 149 are dispersed evenly along a horizontal axis. As another example, the back edge space 316 and the strengthening hole space 313 may not be substantially similar if the strengthening holes 149 are dispersed unevenly along the horizontal axis. Additionally, the horizontal axis on which the strengthening holes are dispersed may be found at any height along the back height 139. For instance, the height may be based at least in part on the size, weight, construction of the stationary equipment. In this example, the horizontal axis is found at a midpoint 319 of the base height 139.

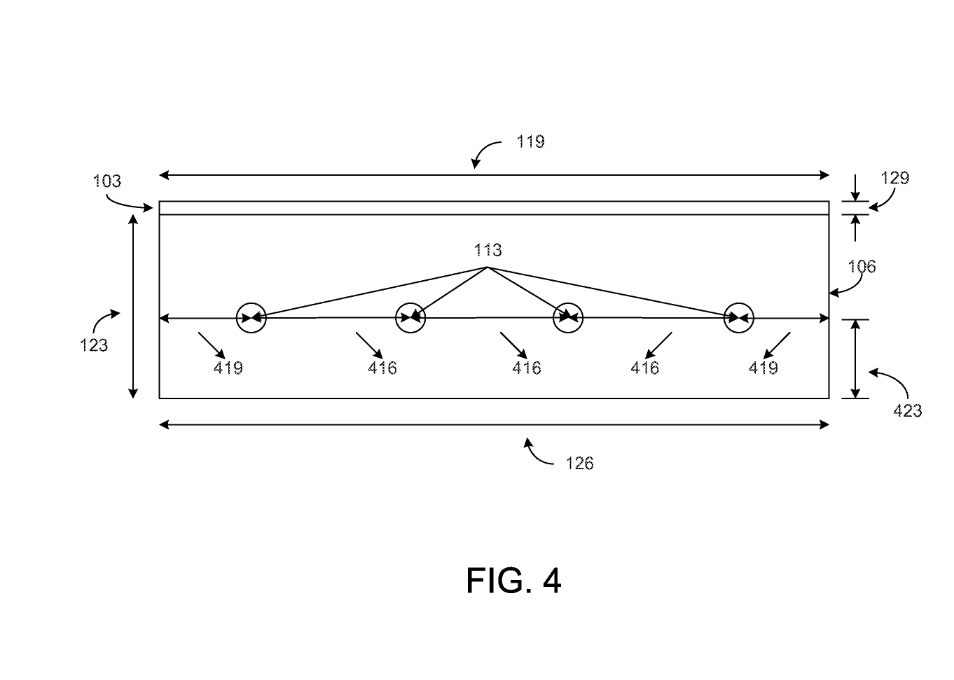

Moving on to FIG. 4, shown is a top view of the front plate 101. In one embodiment, the base wall 106 and the side wall 103 are visible. Further, the visibility of the side wall 103 may depend on the side thickness 129 where a thicker side thickness 129 may result in a more visible side wall 103. Additionally, the side length 119 may be substantially similar to the base length 126. In another embodiment, the side length 119 may vary in size relative to the base length 126 based at least in part on the size, weight, construction, and/or any other feature of the stationary equipment. For instance, the side length 119 and the base length 126 may vary in size to effectively stabilize the stationary equipment.

Next, the base wall 106 includes a plurality of anchoring holes 113 dispersed along the wall. In this example, the base wall 106 includes four anchoring holes 113 that are used to anchor the base wall 106 to an anchor, such as, for instance, a concrete floor, a concrete foundation, and/or any other type of anchor. In particular, the anchoring holes 113 may be configured to receive a concrete bolt, a concrete screw, and/or any other anchoring device capable of anchoring the device 100 to the anchor. Additionally, the diameter of the anchoring holes 113 may vary based at least in part on the diameter of the anchoring devices. In one embodiment, the diameter of the anchoring devices corresponds to the size and weight of the stationary equipment. For instance, a larger anchoring device may be required to effectively secure larger and/or heavier stationary equipment. As an example, the anchoring devices may be ½″ in diameter and thus would require anchoring holes 113 that correspond to that diameter.

In another embodiment, the number and size of anchoring holes 113 may also be based on the type of anchor. Here, four anchoring holes 113 may be necessary to effectively anchor the stationary equipment to a concrete floor. Further, when anchoring devices are inserted into the anchoring holes 113 and firmly applied, the base wall 106 becomes affixed to the anchor, such as a concrete floor. In other embodiments, the number and size of the anchoring holes 113 may also be based on the size, weight, construction and/or any other feature of the stationary equipment.

In one embodiment, the anchoring holes 113 may be dispersed evenly along a horizontal axis of the base wall 106 such that the base edge space 419 between an edge of the base wall 106 and an anchoring hole 113, and the anchoring hole space 416 between the anchoring holes 113 are substantially similar in size. For instance, anchoring holes 113 dispersed evenly along the horizontal axis may be necessary in order to effectively anchor the stationary equipment. In one embodiment, the horizontal axis on which the anchoring holes 113 are located may be located at a base midpoint 423 along the base width 123. In other embodiments, the horizontal axis may be located closer to and/or farther away from the side wall 103 based on the size, weight, construction and/or any other feature of the stationary equipment.

Additionally, the anchoring holes 113 may be dispersed unevenly along a horizontal axis of the base wall 106. In one embodiment, the anchoring hole space 416 may vary in size relative to the base edge space 419 based at least in part on the size, weight, construction and/or any other feature of the stationary equipment. For instance, the anchoring hole space 416 and the base edge space 419 may vary based on the base length 126 to effectively stabilize the stationary equipment. As an example, assuming that the base length 126 is 22″, the anchoring hole space 416 may be 6″ and the base edge space 419 may be 2″ to effectively stabilize the stationary equipment. For example, the construction of the stationary equipment, such as a protrusion in the equipment, may require unevenly dispersed anchoring holes 113.

In another embodiment, the anchoring holes 113 may not all be located on a horizontal axis along the base wall 106. For instance, each of the anchoring holes 113 may be located at varying widths along the base width 123. In particular, each of the anchoring holes 113 may be located closer to and/or farther away from the side wall 103 based at least in part on the size, weight, construction and/or any other feature of the stationary equipment.

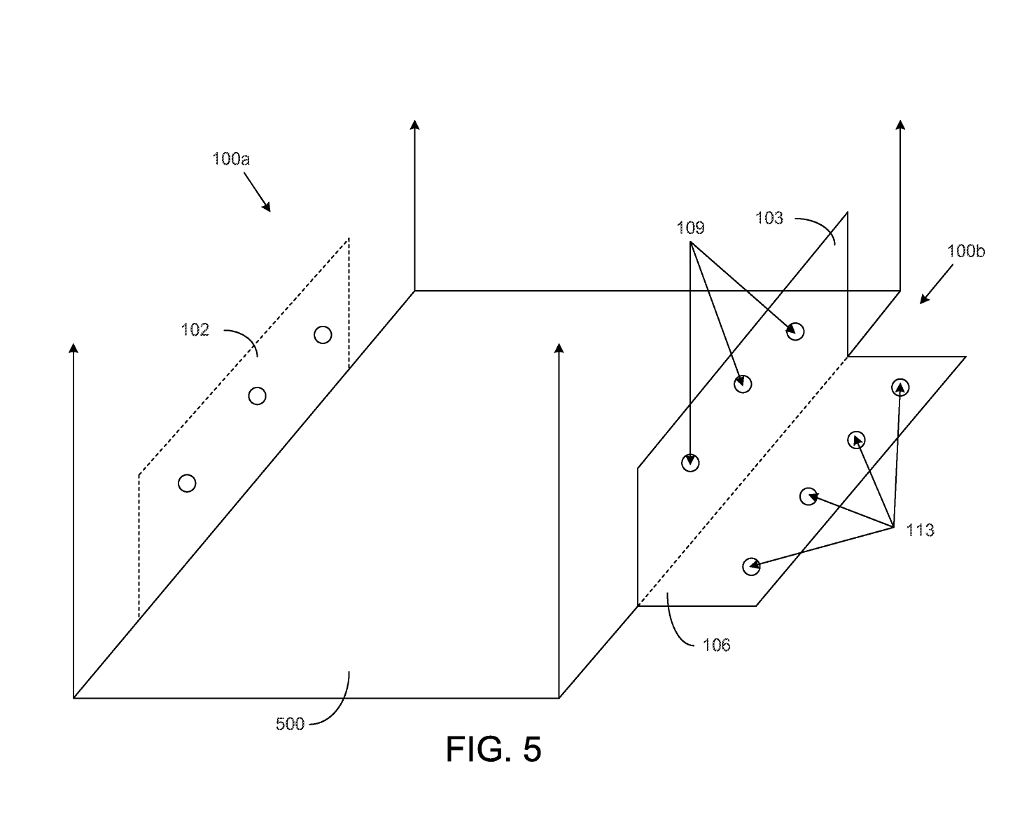

Turning now to FIG. 5, shown is a stationary equipment 500 stabilized by the two devices 100, denoted herein as 100a and 100b. In one embodiment, a left device 100a stabilizes a left side of the stationary equipment 500 and a right device 100b stabilizes a right side of the stationary equipment 500. Referring to the right device 100b, the side wall 103 is secured onto the exterior of the stationary equipment 500 by securing devices inserted into the securing holes 109. A back plate 102 may be positioned on the interior of the stationary equipment 500 where the securing devices are inserted through the stationary equipment 500 and received into the strengthening holes 149 of the back plate 102, as described above. Here, the back plate 102 of the right device 100b is not visible. However, the back plate 102 of the left device 100a is shown as being displaced on the interior of the stationary equipment.

Additionally, the base wall 106 is anchored onto an anchor, such as a concrete floor, by anchoring devices inserted into the anchoring holes 113. As described above, in one embodiment, the side height 116 (FIG. 1), the side length 119 (FIG. 1), the base width 123 (FIG. 1), the base length 126 (FIG. 1), the base height 139 (FIG. 1), the base length 143 (FIG. 1), the diameter of the securing holes 109, the diameter of the anchoring holes 113, the diameter of the strengthening holes 149 the side thickness 129 (FIG. 1), the base thickness 133 (FIG. 1), and the back thickness 146 (FIG. 1) may all vary in size in order to effectively stabilize the stationary equipment 500, based at least in part on the size, weight, construction, and/or any other feature of the stationary equipment 500.

In one embodiment, the left device 100a and the right device 100b function to stabilize the stationary equipment 500 to withstand and resist a dislodging force that may be applied to the stationary equipment. For example, a thief may attempt to dislodge an automatic teller machine (ATM) to overturn the ATM and steal the payload. In this example, the devices 100a/100b may stabilize the ATM to a secured and anchored position such the ATM may withstand and overcome the dislodging force.

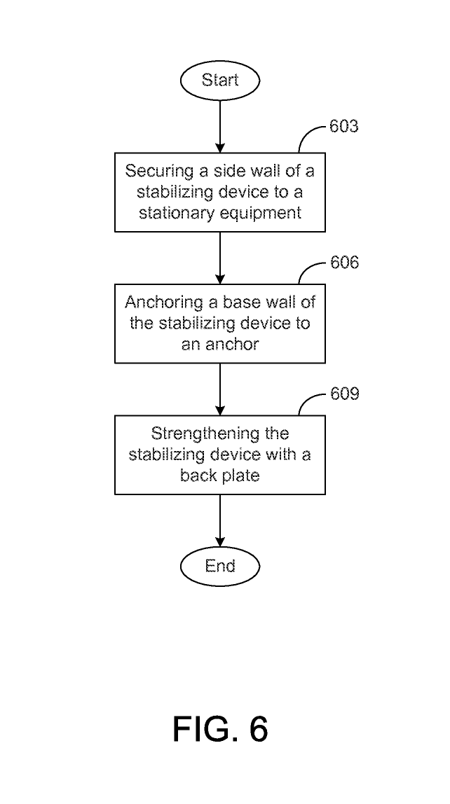

Referring next to FIG. 6, shown is a flowchart that provides one example of the operation of a portion of the device according to various embodiments. It is understood that the flowchart of FIG. 6 provides merely an example of the many different types of functional arrangements that may be employed to implement the operation of the portion of the stabilizing device as described herein.

Beginning with box 603, securing devices may be used for securing a side wall 103 (FIG. 1) of the device to the stationary equipment. In one embodiment, the securing devices may include screws, nails, nut and bolt mechanisms, and/or any other type of securing device. The securing devices may be inserted into securing holes 109 (FIG. 1) dispersed along the side wall of the stabilizing device to affix the side wall to the stationary equipment. Additionally, the number and type of securing devices and securing holes 109 needed to secure the side wall 103 to the stationary equipment may vary based at least in part on the size, weight, construction, and/or any other feature of the stationary equipment. Further, the dimensions of the side wall 103 varies based at least in part on the size, weight, construction and/or any other feature of the stationary equipment.

Next, in box 606, anchoring devices may be used for anchoring a base wall 106 (FIG. 1) of the device to an anchor, such as, for instance, a concrete floor. In one embodiment, the anchoring devices may include concrete bolts, concrete screws, and/or any other type of anchoring device. The anchoring devices may be inserted into the anchoring holes 113 (FIG. 1) dispersed along the base wall of the stabilizing device to affix the base wall to the anchor. Additionally, the number and type of anchoring devices and anchoring holes 113 needed to secure the base wall 106 to the stationary equipment may vary based at least in part on the size, weight, construction and/or any other feature of the stationary equipment. Further, the dimensions of the base wall 106 varies based at least in part on the size, weight, construction and/or any other feature of the stationary equipment.

Additionally, in box 609, strengthening devices may be used to strengthen the back plate 102 (FIG. 1) of the device to the interior of the stationary equipment. In one embodiment, the strengthening device may be the same as the securing device, as discussed above. The strengthening devices may be inserted into the strengthening holes 149 (FIG. 1) dispersed along the back plate 102 of the stabilizing device to strengthen the device while stabilizing the stationary equipment. Additionally, the number and type of strengthening devices and strengthening holes 149 may vary based at least in part on the size, weight, construction and/or any other feature of the stationary equipment. Further, the dimensions of the back plate 102 may be substantially similar to the side wall 103, as discussed above.

Therefore, the following is claimed:

1. A device to stabilize stationary equipment, comprising:
a back plate being displaced on an interior of a stationary equipment; and
a front plate being displaced on an exterior of the stationary equipment, the front plate comprising:
a side wall having a plurality of securing holes dispersed across the wall, wherein the securing holes are configured to each receive at least one of a plurality of securing devices to secure the side wall to the stationary equipment; and
a base wall having a plurality of anchoring holes dispersed across the wall, wherein the anchoring holes are configured to each receive at least one of a plurality of anchoring devices to anchor the base wall to an anchor.

2. The device of claim 1, wherein the back plate and the front plate are comprised of at least one of a heavy gauge steel and a heavy gauge aluminum.

3. The device of claim 1, wherein the device is configured to overcome a dislodging force such that the stationary equipment remains stable.

4. The clamp to secure equipment of claim 1, wherein the side wall comprises three securing holes.

5. The clamp to secure equipment of claim 1, wherein the securing devices comprise at least one of a plurality of bolts, a plurality of nuts, a plurality of screws, and a plurality of nails.

6. The device of claim 1, wherein the base wall comprises four anchoring holes.

7. The device of claim 1, wherein the anchoring devices comprise a plurality of concrete bolts and a plurality of concrete screws.

9. The device of claim 1, wherein the stationary equipment comprises an automatic teller machine.

10. The device of claim 1, wherein the back plate comprises a plurality of strengthening holes configured to each receive at least one of a plurality of strengthening devices.

11. A system, comprising:
a stationary dispensing equipment; and
at least one device disposed on at least one side of the stationary dispensing equipment, wherein the at least one device comprises:
a back plate being displaced on an interior of the stationary dispensing equipment; and
a front plate being displaced on an exterior of the stationary dispensing equipment.

12. The system of claim 11, wherein the front plate comprises:
a side wall having a plurality of securing holes, wherein the securing holes are configured to each receive at least one securing device to secure the side wall to the stationary dispensing equipment; and
a base wall angularly connected to the side wall, the base wall having a plurality of anchoring holes, wherein the anchoring holes are configured to each receive at least one anchoring device to anchor the base wall to an anchor.

13. The system of claim 11, wherein the front plate and the back plate are comprised of at least one of a heavy gauge steel and a heavy gauge aluminum.

14. The system of claim 11, wherein the stationary dispensing equipment is configured to overcome a dislodging force while stabilized by the at least one device.

15. The system of claim 11, wherein the stationary dispensing equipment comprises an automatic teller machine.

16. The system of claim 12, wherein the base wall is connected to the side wall at a ninety degree angle.

17. A method, comprising the steps of:
securing a side wall of a front plate of a device to an exterior portion of a stationary equipment, the side wall comprising a plurality of securing holes, each securing hole configured to receive at least one of a plurality of securing devices;
anchoring a base wall of the front plate of the device to an anchor, the base wall comprising a plurality of anchoring holes, each anchoring hole configured to receive at least one of a plurality of anchoring devices, wherein the side wall and the anchor wall are parallelepiped bodies intersecting to form a right angle; and
strengthening the device with a back plate being displaced on an interior portion of the stationary equipment.

18. The method of claim 17, wherein the front plate and the back plate stabilize the stationary equipment to the anchor.

19. The method of claim 17, wherein the stationary equipment is an automatic teller machine.

20. The method of claim 17, wherein the front plate and the back plate are configured to overcome a dislodging force to stabilize the stationary equipment for a period of time.
